(19) United States
(12) Patent Application Publication
(10) Pub. No.: US 2016/0356562 A1
(43) Pub. Date: Dec. 8, 2016

(54) HEAT EXCHANGER AND METHOD OF MANUFACTURING THE SAME

(71) Applicant: KEIHIN THERMAL TECHNOLOGY CORPORATION, Oyama-shi (JP)

(72) Inventors: Takashi TERADA, Oyama-shi (JP); Hiroshi OTSUKI, Oyama-shi (JP); Mana KOBAYASHI, Oyama-shi (JP)

(73) Assignee: KEIHIN THERMAL TECHNOLOGY CORPORATION, Oyama-shi (JP)

(21) Appl. No.: 15/153,740

(22) Filed: May 13, 2016

(30) Foreign Application Priority Data
Jun. 2, 2015 (JP) 2015-112080

(51) Int. Cl. F28F 19/06; F28F 21/08; F28D 1/053; F28F 1/22; F25B 39/00; B60H 1/32

(52) U.S. Cl. CPC F28F 19/06; F25B 39/00; B60H 1/3227; F28D 1/05391; F28F 1/22; F28F 21/084; F28F 21/081; F25B 39/04

(57) ABSTRACT

The wall of each heat exchange tube of a condenser for a car air conditioner is composed of a core material layer, a first brazing material layer covering the outer surface of the core material layer, and a second brazing material layer covering the inner surface of the core material layer. A Zn diffused layer is formed in an outer surface layer portion of the core material layer. The deepest portion of the Zn diffused layer is located at a position 70 to 100 μm deep from an outermost surface of the wall. The Zn concentration of the outermost surface of the wall of the heat exchange tube is 0.55 mass % or higher. The Zn diffused layer includes a high potential portion whose spontaneous potential is at least 41 mV higher than the spontaneous potential at the boundary between the core material layer and the first brazing material layer.

### BACKGROUND OF THE INVENTION

The present invention relates to a heat exchanger and to a method of manufacturing the same. More particularly, the present invention relates to a heat exchanger which is used as a condenser for a car air conditioner mounted on a vehicle such as an automobile, and to a method of manufacturing the heat exchanger.

In this specification and claims, the term “aluminum” encompasses aluminum alloys in addition to pure aluminum. Also, materials represented by chemical symbols represent pure materials, and the term “Al alloy” means an aluminum alloy.

In this specification, the term “spontaneous potential” of a material refers to the electrode potential of the material within an acidic (pH: 3) aqueous solution of 5% NaCl with respect to a saturated calomel electrode (S.C.E.), which serves as a reference electrode.

A heat exchanger having the following structure has been widely known and used as a condenser for a car air conditioner. The heat exchanger has a plurality of flat heat exchange tubes formed of an aluminum extrudate, header tanks, corrugated aluminum fins, and aluminum side plates. The flat heat exchange tubes are disposed at predetermined intervals in their thickness direction such that they have the same longitudinal direction and their width direction coincides with an air-flow direction. The header tanks are disposed at opposite longitudinal ends of the heat exchange tubes such that their longitudinal directions coincide with the direction in which the heat exchange tubes are juxtaposed. Opposite ends of the heat exchange tubes are connected to the corresponding header tanks. Each of the fins is disposed between adjacent heat exchange tubes or on the outer side of the heat exchange tube at each of opposite ends, and is brazed to the corresponding heat exchange tube(s). The side plates are disposed outward of the fins at opposite ends and are brazed to the corresponding fins. Each of the header tanks is composed of a tubular tank body formed of aluminum and closing members formed of aluminum. The tank body is formed by bending, into a tubular shape, an aluminum brazing sheet having a brazing material layer on each of opposite sides thereof and brazing opposite side edges of the sheet which are butted against each other. The tank body has openings at opposite ends thereof. The closing members are brazed to the opposite ends of the tank body so as to close the openings at the opposite ends. The tank body has a plurality of tube insertion holes elongated in the air-flow direction and spaced from one another in the longitudinal direction of the tank body. An end portion of each heat exchange tube is inserted into the corresponding tube insertion hole and is brazed to the tank body.

The present applicant has proposed a method of manufacturing the above-described heat exchanger (see Japanese Patent No. 4431361). The proposed method includes a step of brazing heat exchanger tube members and heat exchanger fin members. Each tube member is composed of a tube member main body formed from an extrudate made of an Al alloy containing Cu in an amount of 0.3 to 0.6 mass % and Mn in an amount of 0.1 to 0.4 mass %, the balance being Al and unavoidable impurities; and a thermally sprayed Zn layer (2 to 8 g/m²) formed to cover the entire outer peripheral surface of the tube member main body. Each heat exchanger fin member is formed of a brazing sheet which is composed of a core material and a brazing material covering the opposite sides of the core material. The core material is made of an Al alloy containing Zn in an amount of 2.3 to 2.7 mass % and Mn in an amount of 1.1 to 1.3 mass %, the balance being Al and unavoidable impurities. The brazing material is made of an Al alloy containing Si in an amount of 7.9 to 9.5 mass %, Cu in an amount of 0.1 to 0.3 mass %, and Mn in an amount of 0.1 to 0.3 mass %, the balance being Al and unavoidable impurities.

However, since the heat exchange tubes of the heat exchanger manufactured by the method described in the publication are formed from an aluminum extrudate, there is a limit on the reduction of the thickness of the tube wall, and therefore, there can be realized further lightening of the heat exchange tubes and thus, further lightening of the entire heat exchanger.

In order to overcome such a drawback, the present applicant has proposed a heat exchanger which can be manufactured by the method disclosed in the above-described publication and which can be reduced in weight (see Japanese Patent Application Laid-Open (kokai) No. 2013-250018). Each heat exchange tube of the heat exchanger is manufactured by bending a heat exchange material, composed of a core material and a brazing material covering the opposite sides of the core material, to form a flat hollow tubular member, and brazing together joint portions of the flat hollow tubular member.

However, in order to secure a required corrosion resistance while reducing the wall thickness of the heat exchange tubes in the heat exchanger disclosed in the publication, the depth of corrosion occurring in the wall of each heat exchange tube must be decreased.

### SUMMARY OF THE INVENTION

An object of the present invention is to solve the above-described problem and to provide a heat exchanger which can secure a required corrosion resistance while reducing the wall thickness of the heat exchange tubes thereof, and a method of manufacturing the heat exchanger.

A heat exchanger according to the present invention includes a plurality of flat heat exchange tubes disposed at predetermined intervals in their thickness direction such that they have the same longitudinal direction and their width direction coincides with an air-passing direction; and fins each disposed between adjacent heat exchange tubes and brazed to the heat exchange tubes. Each heat exchange tube is manufactured, from a brazing sheet having a thickness of 170 μm or greater and composed of a core material, a first brazing material covering one side of the core material, and a second brazing material covering the other side of the core material, by bending the brazing sheet so as to form a flat, hollow heat exchange tube intermediate such that the first brazing material is located on an outer side thereof and by brazing together portions of the heat exchange tube intermediate to be joined. The core material is made of an Al alloy containing Cu in an amount of 0.3 to 0.5 mass %, Mn in an amount of 0.6 to 1.0 mass %, and Ti in an amount of 0.05 to 0.15 mass %, the balance being Al and unavoidable impurities. The first brazing material is made of an Al alloy containing Si in an amount of 7.0 to 8.0 mass % and Zn in an amount of 2.0 to 3.0 mass %, the balance being Al and unavoidable impurities. The second brazing material is made of an Al alloy containing Si in an amount of 9.5 to 10.5 mass %, the balance being Al and unavoidable impurities. Each of the fins is made of an aluminum bare material. The wall of each heat exchange tube is composed of a core material layer formed of the core material, a first brazing material layer formed of the first brazing material and covering an outer surface of the core material layer, and a second brazing material layer formed of the second brazing material and covering an inner surface of the core material layer. A Zn diffused layer is formed in an outer surface layer portion of the core material layer, and a deepest portion of the Zn diffused layer is located at a depth of 70 to 100 μm from an outermost surface of the wall of the heat exchange tube. The Zn concentration of the outermost surface of the wall of the heat exchange tube is 0.55 mass % or higher. The Zn diffused layer includes a high potential portion whose spontaneous potential is at least 41 mV higher than a spontaneous potential at a boundary between the core material layer and the first brazing material layer.

### BRIEF DESCRIPTION OF THE DRAWINGS

FIG. 1 is a perspective view showing the overall structure of a condenser for a car air conditioner to which a heat exchanger according to the present invention is applied;

FIG. 2 is an enlarged cross-sectional view taken along line A-A of FIG. 1;

FIG. 3 is a partial enlarged view of FIG. 2;

FIG. 4 is a graph showing the Zn concentrations of the wall outermost surfaces of five heat exchange tubes of a condenser manufactured in Example and the depth positions of the deepest portions of the Zn diffused layers of the heat exchange tubes;

FIG. 5 is a graph showing spontaneous potentials at different depths from the wall outermost surface of a single heat exchange tube of the condenser manufactured in Example; and

FIG. 6 is a graph showing spontaneous potentials at different depths from the wall outermost surface of a single heat exchange tube of a condenser manufactured in Comparative Example.

### DESCRIPTION OF THE PREFERRED EMBODIMENT

An embodiment of the present invention will next be described with reference to the drawings. In the embodiment, a heat exchanger according to the present invention is applied to a condenser for a car air conditioner.

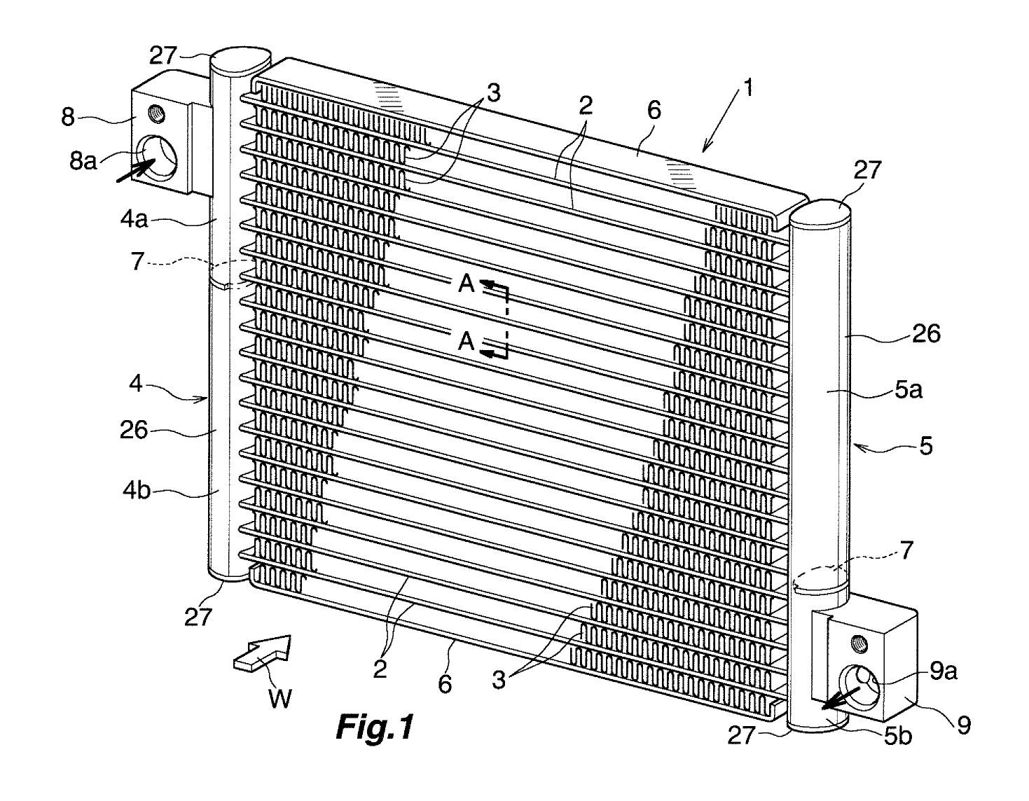

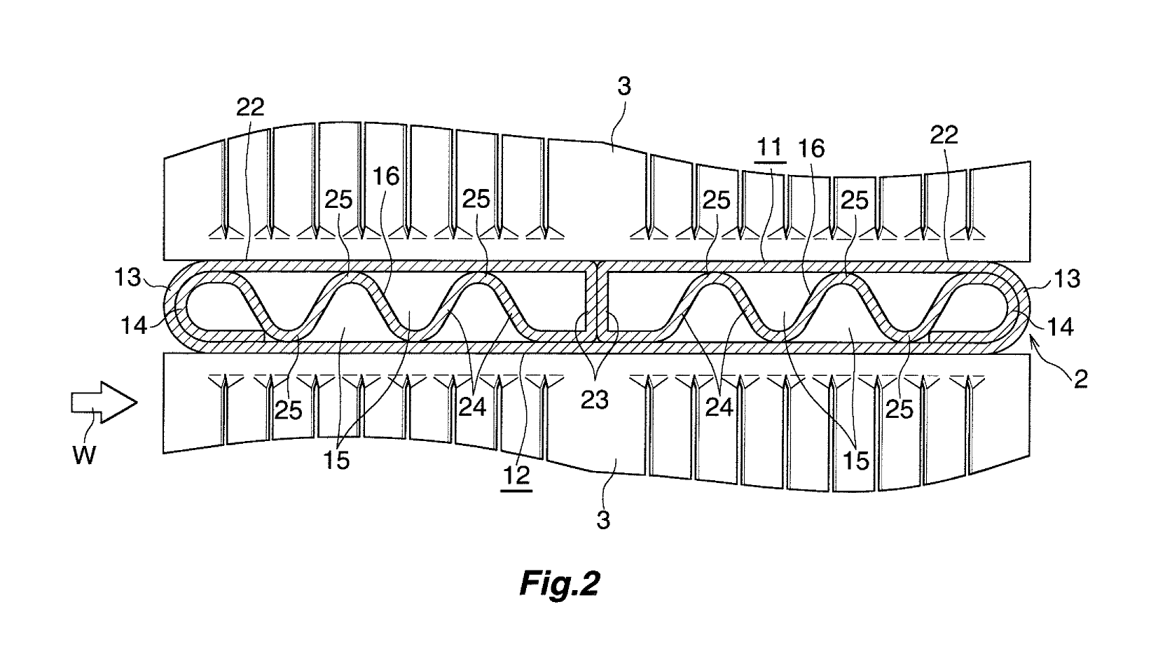

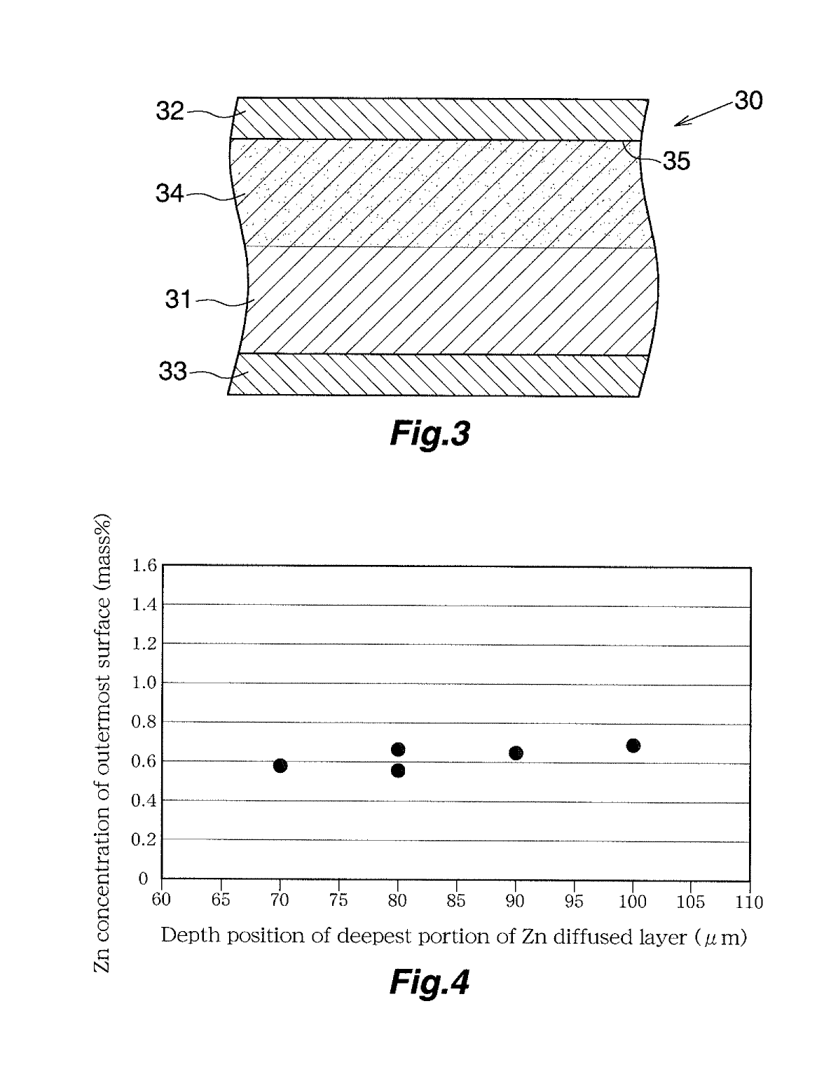

FIG. 1 shows the overall structure of a condenser for a car air conditioner to which a heat exchanger according to the present invention is applied, and FIGS. 2 and 3 show the structure of a main portion of the condenser.

Notably, in the following description, the upper, lower, left-hand, and right-hand sides of FIG. 1 will be referred to as “upper,” “lower,” “left,” and “right,” respectively.

As shown in FIG. 1, a condenser 1 for a car air conditioner includes a plurality of flat heat exchange tubes 2 formed of aluminum, corrugated fins 3 each formed of an aluminum bare material, a pair of header tanks 4 and 5 formed of aluminum, and side plates 6 formed of aluminum. The heat exchange tubes 2 are disposed at predetermined intervals in the vertical direction (the thickness direction of the heat exchange tubes 2) in such a manner that their longitudinal direction coincides with the left-right direction and their width direction coincides with an air-passing direction. The corrugated fins 3 are disposed between adjacent heat exchange tubes 2 and on the outer sides of the uppermost and lowermost heat exchange tubes 2, and are brazed to the corresponding heat exchange tubes 2. The header tanks 4 and 5 are disposed at a predetermined interval in the left-right direction in such a manner that their longitudinal direction coincides with the vertical direction (the direction in which the heat exchange tubes 2 are juxtaposed). Left and right end portions of the heat exchange tubes 2 are connected to the header tanks 4 and 5. The side plates 6 are disposed on the outer sides of the uppermost and lowermost corrugated fins 3, and are brazed to the corresponding corrugated fins 3. Air flows in a direction indicated by an arrow W in FIGS. 1 and 2.

The left header tank 4 is divided by a partition plate 7 into upper and lower header sections 4a and 4b, at a position higher than the center of the left header tank 4 in the height direction. The right header tank 5 is divided by another partition plate 7 into upper and lower header sections 5a and 5b, at a position lower than the center of the right header tank 5 in the height direction. A fluid inlet (not shown) is formed at the upper header section 4a of the left header tank 4, and an aluminum inlet member 8 having a fluid inflow passage 8a communicating with the fluid inlet is brazed to the upper header section 4a. A fluid outlet (not shown) is formed at the lower header section 5b of the right header tank 5, and an aluminum outlet member 9 having a fluid outflow passage 9a communicating with the fluid outlet is brazed to the lower header section 5b. Refrigerant having flowed into the upper header section 4a of the left header tank 4 through the inlet member 8 flows rightward within the heat exchange tubes 2 located above the partition plate 7 of the left header tank 4, and flows into an upper portion of the upper header section 5a of the right header tank 5. The refrigerant then flows downward within the upper header section 5a, flows leftward within the heat exchange tubes 2 whose vertical positons are located between the partition plate 7 of the left header tank 4 and the partition plate 7 of the right header tank 5, and flows into an upper portion of the lower header section 4b of the left header tank 4. The refrigerant then flows downward within the lower header section 4b, flows rightward within the heat exchange tubes 2 located below the partition plate 7 of the right header tank 5, and flows into the lower header section 5b of the right header tank 5. The refrigerant then flows to the outside of the condenser 1 through the outlet member 9.

As shown in FIG. 2, each flat heat exchange tube 2 has a pair of flat walls 11 and 12, two side walls 13, two reinforcing members 14, and two wavy partition plates 16. The flat walls 11 and 12 are spaced from each other in the vertical direction and face each other. The side walls 13 are provided between edge portions of the two flat walls 11 and 12, which edge portions are located on opposite sides in the width direction of the tube. The reinforcing members 14 are provided inward of the two side walls 13. The partition plates 16 are provided in the flat heat exchange tube 2 and divide the internal space into a plurality of refrigerant passages 15 extending in the length direction of the tube.

The entirety of the lower flat wall 12 of the flat heat exchange tube 2 is formed as a single member, and the upper flat wall 11 thereof is composed of two divisional walls 22 juxtaposed in the tube width direction. The side walls 13 which extend in the height direction of the tube (the vertical direction) and have an arcuate transverse cross section projecting outward in the tube width direction are provided between edge portions of the lower flat wall 12 located on the opposite sides in the tube width direction and side edge portions of the two divisional walls 22 located on the outer side in the tube width direction. Projection walls 23 are integrally formed on edge portions of the two divisional walls 22 of the upper flat wall 11 of the flat heat exchange tube 2, which edge portions are located on the inner side in the tube width direction. The projection walls 23 project toward the lower flat wall 12, and their distal ends are in contact with the lower flat wall 12. In this state, the projection walls 23 are brazed to the lower flat wall 12. The projection walls 23 are brazed to each other. The partition plates 16 are integrally formed at the distal ends of the projection walls 23 such that the partition plates 16 extend outward in the tube width direction.

Each of the partition plates 16 is composed of a plurality of partition walls 24 which extend in the tube length direction (in the left-right direction), are juxtaposed in the tube width direction, and each separate adjacent refrigerant passages 15 from each other; and connection portions 25 which alternately connect the upper and lower ends of the partition walls 24 located adjacent to each other in the tube width direction, which are brazed to the inner surfaces of the two flat walls 11 and 12, and which have an arcuate transverse cross section. The reinforcing member 14 is integrally formed such that it is connected to one end (in the tube height direction) of the partition wall 24 at the outer end of each partition plate 16 in the tube width direction. In the present embodiment, the upper end (one end in the tube height direction) of the reinforcing member 14 is connected to the upper end (one end in the tube height direction) of the partition wall 24 at the outer end in the tube width direction.

Each heat exchange tube 2 is manufactured from a brazing sheet for heat exchange tube intermediates which has a thickness of 170 μm or greater and is composed of a core material, a first brazing material covering one side of the core material, and a second brazing material covering the other side of the core material. Specifically, each heat exchange tube 2 is manufactured by bending the brazing sheet so as to form a flat, hollow heat exchange tube intermediate such that the first brazing material is located on the outer side thereof and brazing together portions of the heat exchange tube intermediate to be joined. The core material is made of an Al alloy containing Cu in an amount of 0.3 to 0.5 mass %, Mn in an amount of 0.6 to 1.0 mass %, and Ti in an amount of 0.05 to 0.15 mass %, the balance being Al and unavoidable impurities. The first brazing material is made of an Al alloy containing Si in an amount of 7.0 to 8.0 mass % and Zn in an amount of 2.0 to 3.0 mass %, the balance being Al and unavoidable impurities. The second brazing material is made of an Al alloy containing Si in an amount of 9.5 to 10.5 mass %, the balance being Al and unavoidable impurities.

The core material of the brazing sheet for heat exchange tube intermediates contains, as unavoidable impurities, Si in an amount of 0.2 mass % or less, Fe in an amount of 0.3 mass % or less, and Zn in an amount of 0.1 mass % or less for the following reasons. When the Fe content is high, corrosion speed increases, and corrosion resistance becomes insufficient. When the Zn content is high, a sufficiently large potential difference cannot be produced between the Zn diffused layer and the boundary between the core material layer and the first brazing material layer. In some cases, the amounts of Si, Fe, and Zn contained as unavoidable impurities are zero.

The first brazing material of the brazing sheet for heat exchange tube intermediates contains, as unavoidable impurities, Fe in an amount of 0.5 mass % or less, Cu in an amount of 0.25 mass % or less, and Mn in an amount of 0.1 mass % or less for the following reasons. When the Fe content is high, corrosion speed increases, and corrosion resistance becomes insufficient. When the Cu content is high, a sufficiently large potential difference cannot be produced between the Zn diffused layer and the boundary between the core material layer and the first brazing material layer. In some cases, the amounts of Fe, Cu, and Mn contained as unavoidable impurities are zero.

The second brazing material of the brazing sheet for heat exchange tube intermediates contains, as unavoidable impurities, Fe in an amount of 0.5 mass % or less, Cu in an amount of 0.25 mass % or less, Mn in an amount of 0.1 mass % or less, and Zn in an amount of 0.05 mass % or less for the following reasons. When the Fe content is high, corrosion speed increases, and corrosion resistance becomes insufficient. When the Zn content is high, corrosion resistance becomes insufficient. In some cases, the amounts of Fe, Cu, Mn, and Zn contained as unavoidable impurities are zero.

Since each heat exchange tube 2 is manufactured through use of the brazing sheet described above, as shown in FIG. 3, the wall 30 of each heat exchange tube 2 is composed of a core material layer 31 formed of the core material of the brazing sheet, a first brazing material layer 32 formed of the first brazing material of the brazing sheet and covering the outer surface of the core material layer 31, and a second brazing material layer 33 formed of the second brazing material of the brazing sheet and covering the inner surface of the core material layer 31. A Zn diffused layer 34 is formed in an outer surface layer portion of the core material layer 31, and the deepest portion of the Zn diffused layer 34 is located at a depth of 70 to 100 μm from the outermost surface of the wall 30 of the heat exchange tube 2. The Zn concentration of the outermost surface of the wall 30 of the heat exchange tube 2 is 0.55 mass % or greater. The Zn diffused layer 34 contains a high potential portion having a spontaneous potential at least 41 mV higher than the spontaneous potential at the boundary 35 between the core material layer 31 and the first brazing material layer 32. The boundary 35 between the core material layer 31 and the first brazing material layer 32 of the wall 30 is located at a depth of 17.7 to 35.5 μm from the outermost surface of the wall 30. Since the brazing material flows at the time of brazing, the boundary 36 between the core material layer 31 and the second brazing material layer 33 cannot be specified. The wall 30 of the heat exchange tube 2 refers to each of the lower flat wall 12, the divisional walls 22 constituting the upper flat wall 11, and the two side walls 13.

Notably, the reason why the thickness of the above-described brazing sheet for heat exchange tube intermediates is set to 170 μm or greater is as follows. Namely, the deepest portion of the Zn diffused layer 34 formed in the core material layer 31 of the wall 30 of each heat exchange tube 2 is located at a depth of 70 to 100 μm from the outermost surface of the wall 30 of the heat exchange tube 2. Therefore, if the thickness of the brazing sheet for heat exchange tube intermediates is less than 170 the ratio of the thickness of the Zn diffused layer 34 to the overall thickness of the wall 30 increases, and the heat exchange tube 2 cannot have a sufficiently high corrosion resistance and a sufficiently high withstanding pressure, even if corrosion from the outer surface of the wall 30 of the heat exchange tube 2 stops at the high potential portion present in the Zn diffused layer 34.

It is preferred that each corrugated fin 3 be made of an Al alloy containing Mn in an amount of 1.0 to 1.5 mass % and Zn in an amount of 1.2 to 1.8 mass %, the balance being Al and unavoidable impurities. The reason why the Mn content of each corrugated fin 3 is set to 1.0 to 1.5 mass % is as follows. When the Mn content is excessively low, each corrugated fin 3 itself cannot have a sufficiently high strength. When the Mn content is excessively high, the strength of each corrugated fin 3 becomes excessively high, which lowers formability. Also, the reason why the Zn content of each corrugated fin 3 is set to 1.2 to 1.8 mass % is as follows. When the Zn content is excessively low, each corrugated fin 3 fails to function as a sacrifice anode, whereby the corrosion resistance of the heat exchange tubes 2 lowers. When the Zn content is excessively high, the corrosion resistance of each corrugated fin 3 becomes insufficient.

Each corrugated fin 3 contains, as unavoidable impurities, Si in an amount of 0.6 mass % or less, Fe in an amount of 0.5 mass % or less, Cu in an amount of 0.05 mass % or less, and Cr in an amount of 0.12 mass % or less for the following reasons. When the Fe content is high, the corrosion resistance of each corrugated fin 3 becomes insufficient. When the Cu content is excessively high, each corrugated fin 3 fails to function as a sacrifice anode, whereby the corrosion resistance of the heat exchange tubes 2 lowers. In some case, the amounts of Si, Fe, Cu, and Cr contained as unavoidable impurities are 0.

Each of the left and right header tanks 4 and 5 is composed of a tubular aluminum tank body 26 having openings at opposite ends thereof and aluminum closing members 27 which are brazed to the opposite ends of the tank body 26 so as to close the openings at the opposite ends. The tank body 26 is formed of a brazing sheet having an aluminum core material having a proper alloy composition, and an aluminum brazing material having a proper alloy composition and covering opposite sides of the core material. Specifically, the tank body 26 is formed by bending the brazing sheet into a tubular shape so as to form a tubular tank body intermediate having opposite side edge portions partially overlapping with each other and by brazing together the side edge portions of the tank body intermediate.

Each of the partition plates 7, the closing members 27, the inlet member 8, and the outlet member 9 are formed of aluminum having a proper quality.

The condenser 1 is manufactured by a method described below.

First, a brazing sheet—which has a thickness of 170 μm or greater and which is composed of a core material made of an Al alloy having the above-described alloy composition, a first brazing material made of an Al alloy having the above-described alloy composition and covering one side of the core material, and a second brazing material made of an Al alloy having the above-described alloy composition and covering the other side of the core material—is bent such that the first brazing material is located on the outer surface side, to thereby form a heat exchange tube intermediate which has the same shape as the heat exchange tube 2 and whose portions to be joined are not brazed. The cladding ratio of the first brazing material of the brazing sheet for heat exchange tube intermediates is preferably 16 to 22%, and the cladding ratio of the second brazing material thereof is preferably 8 to 10%.

Also, the corrugated fins 3 made of a bare material having the above-described alloy composition are prepared, and the side plates 6, the partition plates 7, the closing members 27, the inlet member 8, and the outlet member 9 each of which has a proper alloy composition are prepared.

Further, a brazing sheet—which is composed of an aluminum core material having a proper alloy composition and an aluminum brazing material having a proper alloy composition and covering opposite sides of the core material—is bent into a tubular shape to thereby form a tubular tank body intermediate having side edge portions partially overlapping with each other.

Subsequently, the heat exchange tube intermediates, the corrugated fins 3, and the side plates 6 are combined together; each tank body intermediate is combined with the corresponding closing members 27 and the corresponding partition plate 7; and the inlet member 8 and the outlet member 9 are disposed at predetermined positions.

After that, the combination or assembly of the heat exchange tube intermediates, the corrugated fins 3, the side plates 6, the tank body intermediates, the partition plates 7, the closing members 27, the inlet member 8, and the outlet member 9 is heated to a predetermined temperature. As a result, the to-be-joined portions of each heat exchange tube intermediate are brazed together so as to form the heat exchange tubes 2; the joint portions of each tank body intermediate are brazed together so as to form the tank bodies 26; and each tank body 26, the corresponding partition plate 7, and the corresponding closing members 27 are brazed together to form the header tanks 4 and 5. Also, simultaneously with the formation of the heat exchange tubes 2 and the header tanks 4 and 5, the heat exchange tubes 2 and the header tanks 4 and 5 are brazed together; the heat exchange tubes 2 and the corrugated fins 3 are brazed together; the corrugated fins 3 and the side plates 6 are brazed together; the header tank 4 and the inlet member 8 are brazed together; and the header tank 5 and the outlet member 9 are brazed together. Thus, the condenser 1 is manufactured.

In the above-described brazing sheet for heat exchange tube intermediates which is used for manufacture of the condenser 1, the Cu content of the core material is preferably limited to the range of 0.3 to 0.5 mass %, the Zn content of the first brazing material is preferably limited to the range of 2.0 to 3.0 mass %, and the cladding ratio of the first brazing material is preferably set to the range of 16 to 22% on the basis of the results of a test which will be described next.

In the test, twelve types of brazing sheets (thickness: 180 μm) shown in Table 2 were prepared.

TABLE 1

| | Composition (mass %) | | | | | | |
|---|---|---|---|---|---|---|---|
| | Al | Si | Fe | Cu | Mn | Zn | Ti |
| First brazing | Balance | 7.0-8.0 | ≦0.5 | ≦0.25 | ≦0.1 | Shown in | — |
| material | | | | | | Table 2 | |
| Core material | Balance | ≦0.2 | ≦0.3 | Shown in | 0.6-1.0 | ≦0.1 | 0.05-0.15 |
| | | | | Table 2 | | | |
| Second brazing | Balance | 9.5-10.5 | ≦0.5 | ≦0.25 | ≦0.1 | ≦0.05 | — |
| material | | | | | | | |

Table 1 shows the amounts of the alloy components of the core material of each brazing sheet other than Cu, the amounts of the alloy components of the first brazing material of each brazing sheet other than Zn, and the amounts of the alloy components of the second brazing material of each brazing sheet. The Cu content of the core material of each brazing sheet and the Zn content of the first brazing material of each brazing sheet are shown in Table 2. The cladding ratio of the second brazing material is 10%.

TABLE 2

| | | Zn content of | Cladding ratio of | |
|---|---|---|---|---|
| | Cu content of | first brazing | first brazing | |
| Test | core material | material | material | Results of |
| piece | (mass %) | (mass %) | (%) | SWATT test |
| 1 | 0.40 | 2.0 | 11 | x |
| 2 | 0.40 | 2.0 | 16 | ∘ |
| 3 | 0.40 | 2.0 | 22 | ∘ |
| 4 | 0.40 | 3.0 | 11 | x |
| 5 | 0.40 | 3.0 | 16 | ∘ |
| 6 | 0.40 | 3.0 | 22 | ∘ |
| 7 | 0.05 | 2.0 | 11 | x |
| 8 | 0.05 | 2.0 | 16 | x |
| 9 | 0.05 | 2.0 | 22 | x |
| 10 | 0.05 | 3.0 | 11 | x |
| 11 | 0.05 | 3.0 | 16 | x |
| 12 | 0.05 | 3.0 | 22 | x |

Subsequently, test pieces of 60 mm×120 mm were made from the twelve types of aluminum brazing sheets, and all the test pieces were heated in a brazing furnace having a preheating chamber and a brazing chamber filled with nitrogen gas. Specifically, all the test pieces were heated at 500° C. in the preheating chamber for 10 minutes, and then heated at 611° C. in the brazing chamber for 10 minutes.

After that, the SWATT test based on ASTM G85-A3 was carried out for all the test pieces, and their surface conditions were observed. Table 2 shows the results of the test. The mark “0” in the column of “Results of SWATT test” of Table 2 shows that shallow uniform corrosion occurred, and the mark “X” in the column shows that deep local corrosion occurred.

The above-described test results show that it is preferred that, in the brazing sheet for heat exchange tube intermediates, the Cu content of the core material be limited to the range of 0.3 to 0.5 mass %, the Zn content of the first brazing material be limited to the range of 2.0 to 3.0 mass %, and the cladding ratio of the first brazing material be set to the range of 16 to 22%.

A specific example of the present invention will now be described together with a comparative example.

### Example

There was prepared an aluminum brazing sheet for forming heat exchange tubes which was composed of a core material, a first brazing material covering one side of the core material, and a second brazing material covering the other side of the core material. The core material contains Cu in an amount of 0.4 mass %, Mn in an amount of 0.8 mass %, and Ti in an amount of 0.1 mass %, the balance being Al and unavoidable impurities. The first brazing material contains Si in an amount of 7.5 mass % and Zn in an amount of 2.0 mass %, the balance being Al and unavoidable impurities. The second brazing material contains Si in an amount of 10 mass %, the balance being Al and unavoidable impurities. The cladding ratio of the first brazing material of the aluminum brazing sheet for forming heat exchange tubes is 16%, and the cladding ratio of the second brazing material thereof is 10%. The amount of Si contained in the core material as an unavoidable impurity is 0.09 mass %, and the amount of Fe contained in the core material as an unavoidable impurity is 0.09 mass %. The amount of Fe contained in the first brazing material as an unavoidable impurity is 0.25 mass %. The amount of Cu contained in the second brazing material as an unavoidable impurity is 0.04 mass %, and the amount of Fe contained in the second brazing material as an unavoidable impurity is 0.28 mass %. The amount of each of unavoidable impurity elements, other than the above-described unavoidable impurities, in the core material, the first brazing material, and the second brazing material is 0.05 mass % or less, and the total amount of the unavoidable impurity elements, other than the above-described unavoidable impurities, is 0.15 mass %.

Also, there were prepared corrugated fins 3 formed from a bare material made of an Al alloy containing Mn in an amount of 1.03 mass % and Zn in an amount of 1.43 mass %, the balance being Al and unavoidable impurities. The amount of Si contained in the corrugated fins 3 as an unavoidable impurity is 0.34 mass %, and the amount of Fe contained in the corrugated fins 3 as an unavoidable impurity is 0.44 mass %. The amount of each of unavoidable impurity elements, other than the above-described unavoidable impurities, in the corrugated fins 3 is 0.05 mass % or less, and the total amount of the unavoidable impurity elements, other than the above-described unavoidable impurities, is 0.15 mass %.

Further, there were prepared the partition plates 7, the closing members 27, the inlet members 8, and the outlet members 9 each having a proper alloy composition. Further, tube insertion holes were formed at the widthwise center of each brazing sheet for tank body composed of an aluminum core material having a proper alloy composition and an aluminum brazing material having a proper alloy composition and covering opposite sides of the core material. After that, the brazing sheet was formed into a tubular shape such that opposite side edges of the brazing sheet partially overlapped with each other. Thus, there was manufactured tank body intermediates each having a shape similar to that of the tank bodies 26 and having opposite side edges not brazed together.

After that, the condenser 1 was manufactured in the same manner as described above.

Five heat exchange tubes 2 were cut off from the manufactured condenser 1, and the wall 30 of each heat exchange tube 2 was observed. The observation revealed that the Zn diffused layer 34 was formed in the outer surface layer portion of the core material layer 31 of the wall 30. The depth position of the deepest portion of the Zn diffused layer 34 from the outermost surface of the wall 30 and the Zn concentration of the outermost surface of the wall 30 were measured. As shown in FIG. 4, the depth position of the deepest portion of the Zn diffused layer 34 from the outermost surface of the wall 30 was 70 to 100 μm, and the Zn concentration of the outermost surface of the wall 30 was 0.55 mass % or higher. Notably, the thickness of the wall was 180 μm.

Also, one heat exchange tube 2 and a corrugated fin 3 brazed to that heat exchange tube 2 were cut off from the manufactured condenser 1, and the spontaneous potential of the outermost surface of the wall 30 of the heat exchange tube 2, the spontaneous potential of the Zn diffused layer 34, the spontaneous potential of the corrugated fin 3, and the spontaneous potential of a fillet formed between the heat exchange tube 2 and the corrugated fin 3 were measured. Table 3 shows the measured spontaneous potentials.

TABLE 3

| | Outermost | Zn diffused | | |
|---|---|---|---|---|
| | surface of heat | layer of heat | Corrugated | |
| | exchange tube | exchange tube | fin | Fillet |
| Spontaneous | −743 mV | −708 mV | −827 mV | −757 mV |
| potential | | | | |

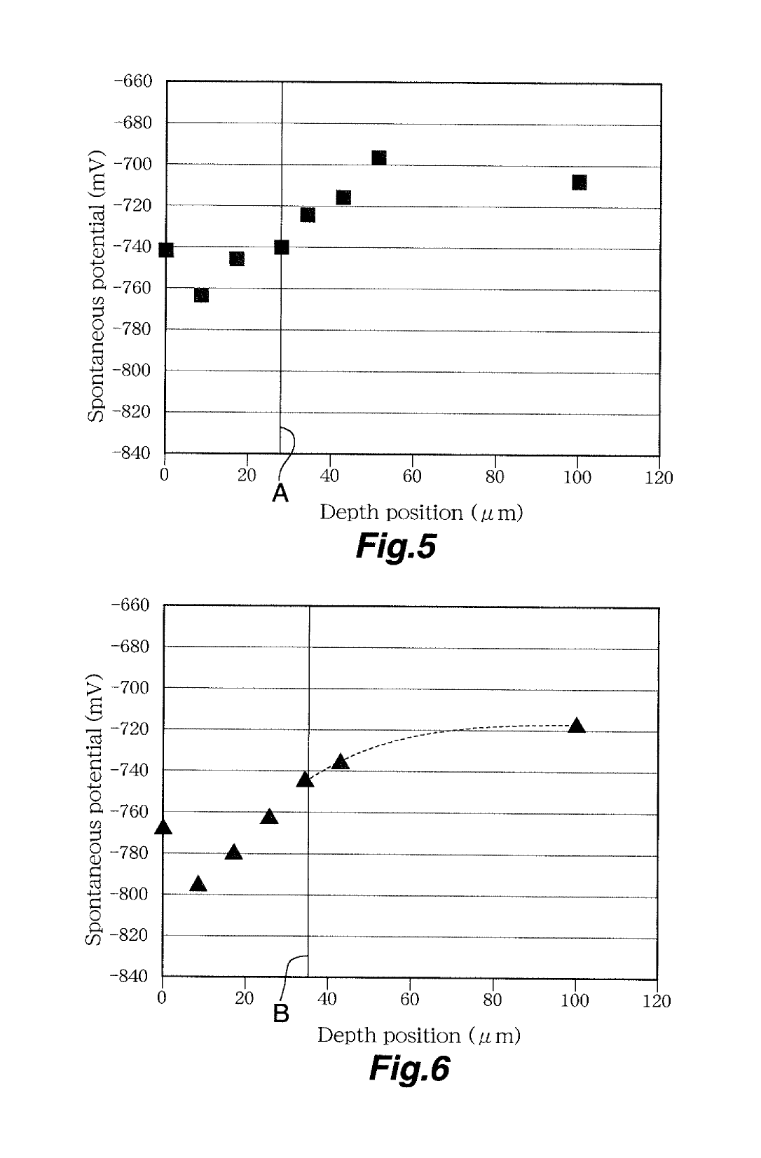

Also, one heat exchange tube 2 was cut off from the manufactured condenser 1, and spontaneous potentials at different depth positions from the outermost surface of the wall 30 were measured. FIG. 5 shows the measured spontaneous potentials. Notably, the thickness of the wall 30 was 180 μm. As shown in FIG. 5, the boundary 35 between the core material layer 31 and the first brazing material layer 32 of the wall 30 was located at a position indicated by a straight line A; namely, located at a depth of 28.8 μm from the outermost surface. The deepest portion of the Zn diffused layer 34 was located at a depth of 100 μm from the outermost surface of the wall 30. It is found from the results shown in FIG. 5 that a portion whose spontaneous potential is at least 41 mV higher than the spontaneous potential at the boundary 35 between the core material layer 31 and the first brazing material layer 32 exists in the Zn diffused layer 34.

Further, after the CCT test was carried out on the manufactured condenser 1 for 240 days, five heat exchange tubes 2 were cut off, and the depth of corrosion of the wall 30 of each heat exchange tube 2 from the outermost surface thereof was measured. The measured maximum corrosion depth was 46 μm.

### Comparative Example

There was prepared an aluminum brazing sheet for forming heat exchange tubes which was composed of a core material, a first brazing material covering one side of the core material, and a second brazing material covering the other side of the core material. The core material contains Cu in an amount of 0.4 mass %, Mn in an amount of 0.8 mass %, and Ti in an amount of 0.1 mass %, the balance being Al and unavoidable impurities. The first brazing material contains Si in an amount of 7.5 mass % and Zn in an amount of 2.0 mass %, the balance being Al and unavoidable impurities. The second brazing material has the same alloy composition as that of Example. The cladding ratio of the first brazing material of the aluminum brazing sheet for forming heat exchange tubes is 16%, and the cladding ratio of the second brazing material thereof is 10%. The amount of Si contained in the core material as an unavoidable impurity is 0.1 mass %, the amount of Fe contained in the core material as an unavoidable impurity is 0.1 mass %, and the amount of Zn contained in the core material as an unavoidable impurity is 0.01 mass %. The amount of Cu contained in the first brazing material as an unavoidable impurity is 0.02 mass %, and the amount of Fe contained in the first brazing material as an unavoidable impurity is 0.27 mass %. The amount of each of unavoidable impurity elements, other than the above-described unavoidable impurities, in the core material and the two brazing materials is 0.05 mass % or less, and the total amount of the unavoidable impurity elements, other than the above-described unavoidable impurities, is 0.15 mass %.

Other components were prepared under the same conditions as those of the above-described Example and a condenser was manufactured through use of the prepared components.

One heat exchange tube was cut off from the manufactured condenser, and spontaneous potentials at different depth positions from the outermost surface of the wall were measured. FIG. 6 shows the measured spontaneous potentials. Notably, the thickness of the wall was 225 μm. As shown in FIG. 6, the boundary between the core material layer and the first brazing material layer of the wall was located at a position indicated by a straight line B; namely, located at a depth of 33.8 μm from the outermost surface. The deepest portion of the Zn diffused layer was located at a depth of 100 μm from the outermost surface of the wall. It is found from the results shown in FIG. 6 that only a portion whose spontaneous potential is at most 29 mV higher than the spontaneous potential at the boundary between the core material layer and the first brazing material layer exists in the Zn diffused layer.

Further, after the CCT test was carried out on the manufactured condenser for 240 days, five heat exchange tubes 2 were cut off, and the depth of corrosion of the wall of each heat exchange tube from the outermost surface thereof was measured. The measured maximum corrosion depth was 100 μm.

The present invention comprises the following modes.

1) A heat exchanger comprising a plurality of flat heat exchange tubes disposed at predetermined intervals in their thickness direction such that they have the same longitudinal direction and their width direction coincides with an air-passing direction; and fins each disposed between adjacent heat exchange tubes and brazed to the heat exchange tubes,

wherein each heat exchange tube is manufactured, from a brazing sheet having a thickness of 170 μm or greater and composed of a core material, a first brazing material covering one side of the core material, and a second brazing material covering the other side of the core material, by bending the brazing sheet so as to form a flat, hollow heat exchange tube intermediate such that the first brazing material is located on an outer side thereof and by brazing together portions of the heat exchange tube intermediate to be joined, the core material being made of an Al alloy containing Cu in an amount of 0.3 to 0.5 mass %, Mn in an amount of 0.6 to 1.0 mass %, and Ti in an amount of 0.05 to 0.15 mass %, the balance being Al and unavoidable impurities, the first brazing material being made of an Al alloy containing Si in an amount of 7.0 to 8.0 mass % and Zn in an amount of 2.0 to 3.0 mass %, the balance being Al and unavoidable impurities, and the second brazing material being made of an Al alloy containing Si in an amount of 9.5 to 10.5 mass %, the balance being Al and unavoidable impurities; and

each of the fins is made of an aluminum bare material, and

wherein each heat exchange tube has a wall composed of a core material layer formed of the core material, a first brazing material layer formed of the first brazing material and covering an outer surface of the core material layer, and a second brazing material layer formed of the second brazing material and covering an inner surface of the core material layer;

a Zn diffused layer is formed in an outer surface layer portion of the core material layer, and a deepest portion of the Zn diffused layer is located at a depth of 70 to 100 μm from an outermost surface of the wall of the heat exchange tube;

a Zn concentration of the outermost surface of the wall of the heat exchange tube is 0.55 mass % or higher; and

the Zn diffused layer includes a high potential portion whose spontaneous potential is at least 41 mV higher than a spontaneous potential at a boundary between the core material layer and the first brazing material layer.

2) A heat exchanger according to par. 1), wherein each of the fins is made of an Al alloy containing Mn in an amount of 1.0 to 1.5 mass % and Zn in an amount of 1.2 to 1.8 mass %, the balance being Al and unavoidable impurities.

3) A method of manufacturing a heat exchanger according to par. 1), the method comprising:

forming each heat exchange tube, from a brazing sheet having a thickness of 170 μm or greater and composed of a core material, a first brazing material covering one side of the core material, and a second brazing material covering the other side of the core material, by bending the brazing sheet so as to form a flat, hollow heat exchange tube intermediate and brazing together portions of the heat exchange tube intermediate to be joined, the core material being made of an Al alloy containing Cu in an amount of 0.3 to 0.5 mass %, Mn in an amount of 0.6 to 1.0 mass %, and Ti in an amount of 0.05 to 0.15 mass %, the balance being Al and unavoidable impurities, the first brazing material being made of an Al alloy containing Si in an amount of 7.0 to 8.0 mass % and Zn in an amount of 2.0 to 3.0 mass %, the balance being Al and unavoidable impurities, and the second brazing material being made of an Al alloy containing Si in an amount of 9.5 to 10.5 mass %, the balance being Al and unavoidable impurities; and

brazing, simultaneously with the formation of the heat exchange tubes, the formed heat exchange tubes and the fins formed of the aluminum bare material.

4) A heat exchanger manufacturing method according to par. 3), wherein a cladding ratio of the first brazing material of the brazing sheet for forming the heat exchange tube intermediate is 16 to 22%.

5) A heat exchanger manufacturing method according to par. 3) or 4), wherein each of the fins is made of an Al alloy containing Mn in an amount of 1.0 to 1.5 mass % and Zn in an amount of 1.2 to 1.8 mass %, the balance being Al and unavoidable impurities.

In the heat exchangers of par. 1) or 2), the wall of each heat exchange tube is composed of a core material layer formed of the core material, a first brazing material layer formed of the first brazing material and covering an outer surface of the core material layer, and a second brazing material layer formed of the second brazing material and covering an inner surface of the core material layer; a Zn diffused layer is formed in an outer surface layer portion of the core material layer, and a deepest portion of the Zn diffused layer is located at a depth of 70 to 100 μm from an outermost surface of the wall of the heat exchange tube; a Zn concentration of the outermost surface of the wall of the heat exchange tube is 0.55 mass % or higher; and the Zn diffused layer includes a high potential portion whose spontaneous potential is at least 41 mV higher than a spontaneous potential at a boundary between the core material layer and the first brazing material layer. Therefore, corrosion from the outer surface of the wall of each heat exchange tube stops at the above-mentioned high potential portion. Accordingly, the corrosion depth can be made shallow, whereby the corrosion resistance of the heat exchange tubes is improved. As a result, the thickness of the wall of each heat exchange tube can be decreased, whereby the weight of the heat exchange tubes can be decreased, and thus, the weight of the heat exchanger can be decreased.

According to the heat exchanger of par. 2), through use of a bare material for the fins, the fins have an improved corrosion resistance as compared with the case where a brazing sheet is used for the fins.

According to the manufacturing method of any of pars. 3) to 5), the heat exchanger of par. 1) can be manufactured relatively simply.

According to the manufacturing method of par. 5), through use of a bare material for the fins, the fins have an improved corrosion resistance as compared with the case where a brazing sheet is used for the fins.

What is claimed is:

1. A heat exchanger comprising a plurality of flat heat exchange tubes disposed at predetermined intervals in their thickness direction such that they have the same longitudinal direction and their width direction coincides with an air-passing direction; and fins each disposed between adjacent heat exchange tubes and brazed to the heat exchange tubes,
wherein each heat exchange tube is manufactured, from a brazing sheet having a thickness of 170 μm or greater and composed of a core material, a first brazing material covering one side of the core material, and a second brazing material covering the other side of the core material, by bending the brazing sheet so as to form a flat, hollow heat exchange tube intermediate such that the first brazing material is located on an outer side thereof and by brazing together portions of the heat exchange tube intermediate to be joined, the core material being made of an Al alloy containing Cu in an amount of 0.3 to 0.5 mass %, Mn in an amount of 0.6 to 1.0 mass %, and Ti in an amount of 0.05 to 0.15 mass %, the balance being Al and unavoidable impurities, the first brazing material being made of an Al alloy containing Si in an amount of 7.0 to 8.0 mass % and Zn in an amount of 2.0 to 3.0 mass %, the balance being Al and unavoidable impurities, and the second brazing material being made of an Al alloy containing Si in an amount of 9.5 to 10.5 mass %, the balance being Al and unavoidable impurities; and
each of the fins is made of an aluminum bare material, and
wherein each heat exchange tube has a wall composed of a core material layer formed of the core material, a first brazing material layer formed of the first brazing material and covering an outer surface of the core material layer, and a second brazing material layer formed of the second brazing material and covering an inner surface of the core material layer;
a Zn diffused layer is formed in an outer surface layer portion of the core material layer, and a deepest portion of the Zn diffused layer is located at a depth of 70 to 100 μm from an outermost surface of the wall of the heat exchange tube;
a Zn concentration of the outermost surface of the wall of the heat exchange tube is 0.55 mass % or higher; and
the Zn diffused layer includes a high potential portion whose spontaneous potential is at least 41 mV higher than a spontaneous potential at a boundary between the core material layer and the first brazing material layer.

2. A heat exchanger according to claim 1, wherein each of the fins is made of an Al alloy containing Mn in an amount of 1.0 to 1.5 mass % and Zn in an amount of 1.2 to 1.8 mass %, the balance being Al and unavoidable impurities.

3. A method of manufacturing a heat exchanger according to claim 1, the method comprising:
forming each heat exchange tube, from a brazing sheet having a thickness of 170 μm or greater and composed of a core material, a first brazing material covering one side of the core material, and a second brazing material covering the other side of the core material, by bending the brazing sheet so as to form a flat, hollow heat exchange tube intermediate and brazing together portions of the heat exchange tube intermediate to be joined, the core material being made of an Al alloy containing Cu in an amount of 0.3 to 0.5 mass %, Mn in an amount of 0.6 to 1.0 mass %, and Ti in an amount of 0.05 to 0.15 mass %, the balance being Al and unavoidable impurities, the first brazing material being made of an Al alloy containing Si in an amount of 7.0 to 8.0 mass % and Zn in an amount of 2.0 to 3.0 mass %, the balance being Al and unavoidable impurities, and the second brazing material being made of an Al alloy containing Si in an amount of 9.5 to 10.5 mass %, the balance being Al and unavoidable impurities; and
brazing, simultaneously with the formation of the heat exchange tubes, the formed heat exchange tubes and the fins formed of the aluminum bare material.

4. A heat exchanger manufacturing method according to claim 3, wherein a cladding ratio of the first brazing material of the brazing sheet for forming the heat exchange tube intermediate is 16 to 22%.

5. A heat exchanger manufacturing method according to claim 3, wherein each of the fins is made of an Al alloy containing Mn in an amount of 1.0 to 1.5 mass % and Zn in an amount of 1.2 to 1.8 mass %, the balance being Al and unavoidable impurities.

6. A heat exchanger manufacturing method according to claim 4, wherein each of the fins is made of an Al alloy containing Mn in an amount of 1.0 to 1.5 mass % and Zn in an amount of 1.2 to 1.8 mass %, the balance being Al and unavoidable impurities.
